(19) United States
(12) Patent Application Publication
(10) Pub. No.: US 2012/0322022 A1
(43) Pub. Date: Dec. 20, 2012

(54) TOOTH VITALITY TESTER

(75) Inventors: Randal P. Garvey, New Albany, OH (US); Matthew R. Burris, Bloomington, IN (US)

(73) Assignee: GARBIN DEVELOPMENT, New Albany, OH (US)

(21) Appl. No.: 13/450,806

(22) Filed: Apr. 19, 2012

Related U.S. Application Data
(60) Provisional application No. 61/497,741, filed on Jun. 16, 2011.

(51) Int. Cl. A61C 19/04; A61C 19/06; A61C 3/00

(52) U.S. Cl. 433/27; 433/215; 433/32

(57) ABSTRACT

One example embodiment includes a system for testing the vitality of a tooth. The system includes a stimulus output. The stimulus output is configured to produce a stimulus and output the stimulus to a tooth of a patient. The system also includes a controller, where the controller is configured to control the magnitude and duration of the stimulus produced by the stimulus output.

### CROSS-REFERENCE TO RELATED APPLICATIONS

This application claims the benefit of and priority to U.S. Provisional Patent Application Ser. No. 61/497,741 filed on Jun. 16, 2011, which application is incorporated herein by reference in its entirety.

### BACKGROUND OF THE INVENTION

Testing the health and/or sensitivity of a tooth is a difficult procedure. This is caused, at least in part, because much of the process is subject to human error. For example, if one patient complains of sensitivity to cold, that may mean something vastly different than the same complaint from a different patient who uses the exact same language. For example, does it mean that any cold makes the tooth sensitive? Just cold drinks? How badly does it hurt? Which tooth hurts? Where on the tooth does it hurt? These questions may not be answerable or the answers provided may be highly subjective based on the person giving the answer.

To help “standardize” this, dentists or others may try to perform repeatable tests, in order to determine the patient's reaction. For example, the dentist may have the patient swish tap water over the tooth and then describe what he/she is feeling. However, the temperature of the water can vary greatly based on conditions. For example, as the day warms up, the tap water may also increase in temperature. This may be true of any stimulus applied to the patient's tooth.

Accordingly, there is a need in the art for a system which can produce repeatable stimuli to compare results from one patient to another. In addition, there is a need in the art for the repeatable stimuli to be produced to compare one tooth to another within a single patient. Further, there is a need in the art for the system to be able to produce multiple stimuli. Moreover, there is a need in the art for the system to be compact enough to be used in a dental office without wasting space. In addition, there is a need in the art for the system to be easily sanitized between patient uses.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for testing the vitality of a tooth. The system includes a stimulus output. The stimulus output is configured to produce a stimulus and output the stimulus to a tooth of a patient. The system also includes a controller, where the controller is configured to control the magnitude and duration of the stimulus produced by the stimulus output.

Another example embodiment includes a system for testing the vitality of a tooth. The system includes a body. The body includes a user interface, where the user interface allows a user to input one or more commands and a power source. The system also includes a stimulus apparatus, where the stimulus apparatus is configured to produce a stimulus. The system further includes a tip, where the tip is configured to deliver the stimulus to the tooth of a patient.

Another example embodiment includes a system for testing the vitality of a tooth. The system includes a body. The body includes a user interface, where the user interface allows a user to input one or more commands. The body also includes an electronic display, where the electronic display is configured to produce information to be received by a user. The body further includes a controller, where the controller is configured to control the production of a stimulus. The body additionally includes a tip connection, a power source and a power input. The system also includes a stimulus apparatus, where the stimulus apparatus is configured to produce a stimulus. The system further includes a tip, where the tip is configured to deliver the stimulus to the tooth of a patient. The tip includes a body connection, where the body connection is configured to mate with the tip connection of the body. The tip also includes a transfer apparatus, where the transfer apparatus is configured to transmit signals from the body to the tip. The tip further includes a stimulus conductor, where the stimulus conductor is configured to transfer the stimulus to the tooth of the patient.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of a system for testing the vitality of a tooth;

FIG. 2 illustrates an example of a tooth vitality tester;

FIG. 3A illustrates a front perspective view of the body;

FIG. 3B illustrates a rear perspective view of the body;

FIG. 4A shows a side cut away view of the tip;

FIG. 4B shows a perspective view of the tip; and

FIG. 5 illustrates a perspective view of a charger.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

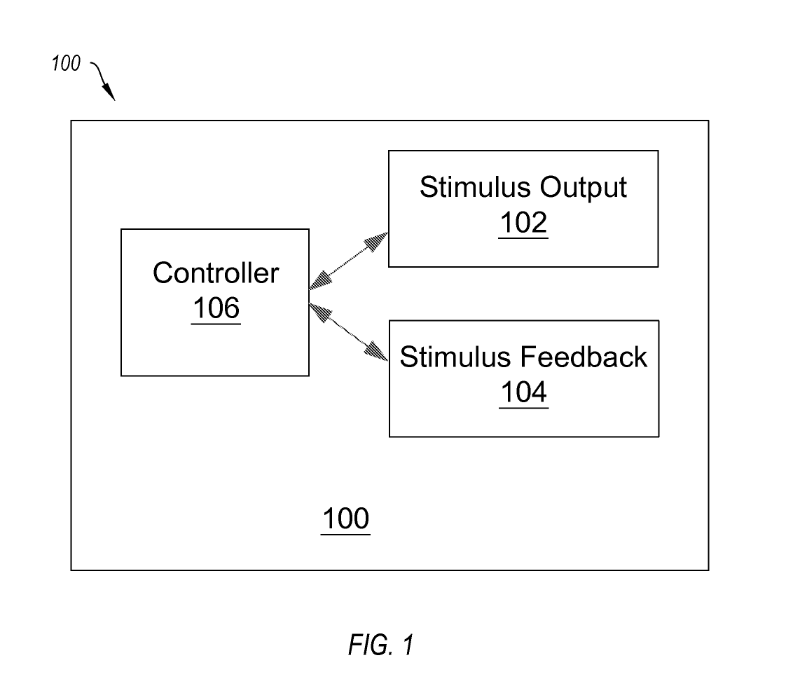

FIG. 1 is a block diagram illustrating an example of a system 100 for testing the vitality of a tooth. In at least one implementation, the vitality of the tooth can include any aspect of tooth health. For example, the vitality of the tooth can include how sensitive the tooth is to stimuli, such as heat, cold, pressure or electric shock. In addition, the vitality of the tooth can include how much enamel remains on the tooth or any other health measurement.

FIG. 1 shows that the system 100 can include a stimulus output 102. In at least one implementation, the stimulus output 102 can be configured to provide a stimulus to an individual tooth. For example, the stimulus output 102 can provide a desired stimulus which is transported to the desired area on a tooth, as described below. E.g., the stimulus can include an electric shock, to determine tooth sensitivity or other stimuli, as described below.

FIG. 1 shows that the system 100 can include a stimulus feedback 104. In at least one implementation, the stimulus feedback 104 can receive feedback after the applied stimulus. For example, if the stimulus output 102 includes an electric shock, the stimulus feedback 104 can measure the current returned from the tooth. The measure of the current returned can indicate tooth vitality factors, such as sensitivity, enamel depth, enamel strength and other vitality factors.

FIG. 1 further shows that the system 100 can include a controller 106. In at least one implementation the controller 106 can control the stimulus output 102 and the stimulus feedback 104. For example, if the stimulus output 102 includes an electric shock, the controller 106 can prompt the stimulus output 102 to produce the desired electrical output. Likewise, the controller 106 can prompt the stimulus feedback 104 to measure the returning current and determine the health of the tooth based on the measurement.

Additionally or alternatively, the controller 106 can include one or more safety systems. For example, the controller 106 can determine whether the measurements from the stimulus feedback 104 and shut down the stimulus output 102. E.g., if the temperature as measured by the stimulus feedback 104 becomes too hot, the controller can instruct the stimulus output 102 to discontinue heating. The safety mechanisms can include software, hardware or both to ensure patient safety.

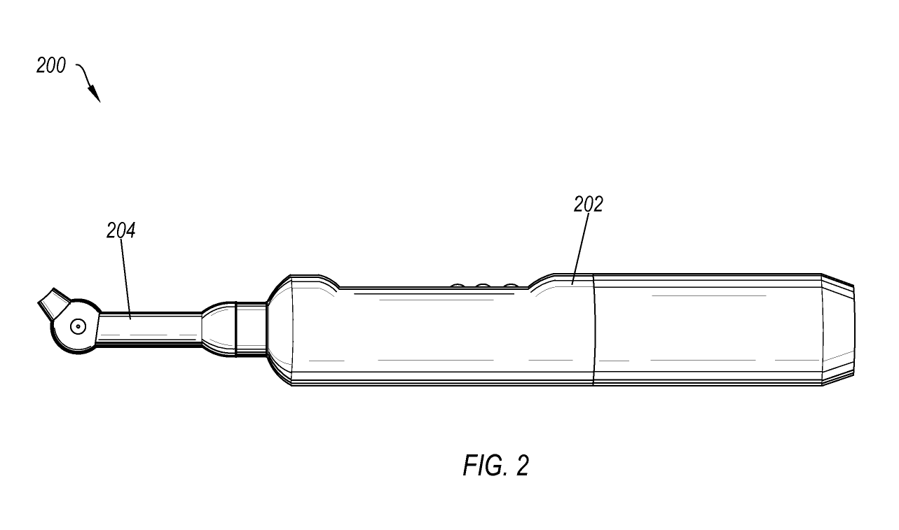

FIG. 2 illustrates an example of a tooth vitality tester 200. In at least one implementation, the tooth vitality tester 200 is configured to test the health of a tooth. In particular, the tooth vitality tester 200 can produce a stimulus which is repeatable and allows a heath professional to evaluate the health of the tooth. For example, the tooth vitality tester 200 can produce heat, cold, electric current, pressure or any other desired stimulus.

FIG. 2 shows that the tooth vitality tester 200 can include a body 202. In at least one implementation, the body 202 can include one or more of the other components present in the tooth vitality tester 200. For example, the body 202 can include a heating element which produces heat. The heat can then be moved from the body 202 to the desired output. Additionally or alternatively, the body 202 can include a power source. The power source can provide or receive the power necessary to run the tooth vitality tester 200.

FIG. 2 also shows that the tooth vitality tester 200 can include a tip 204. In at least one implementation, the tip 204 can transmit the desired stimulus to a patient's tooth. For example, heat, cold, electrical stimulus, pressure or any other desired stimulus can be produced in the body 202 and transmitted to the tip 204. Additionally or alternatively, the stimulus can be produced within the tip 204 and transmitted to the exterior of the tip where it is applied to the patient's tooth.

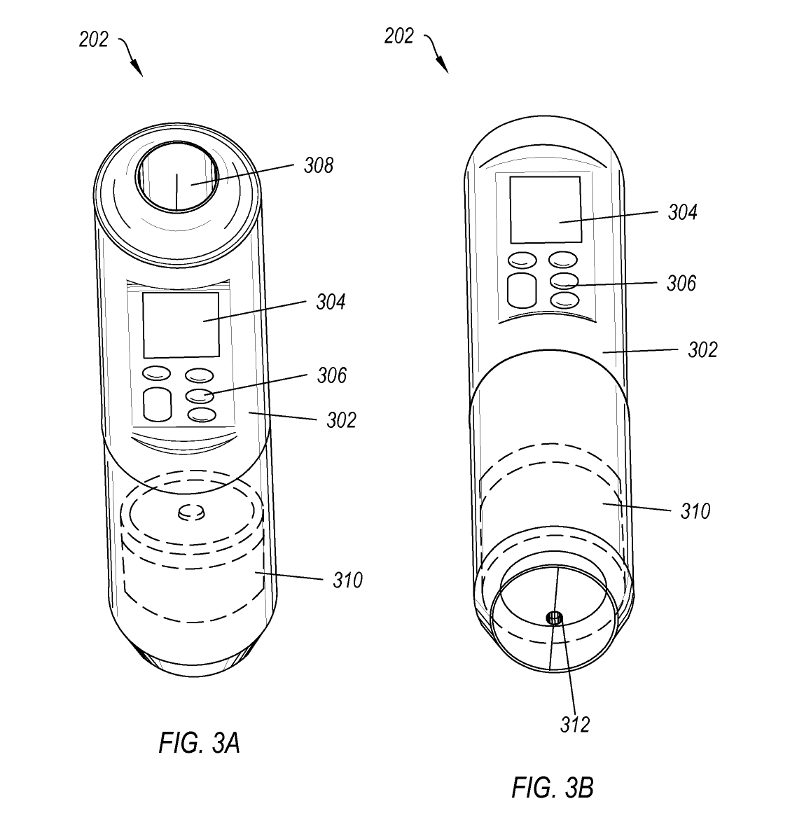

FIGS. 3A and 3B illustrate an example of a body 202. FIG. 3A illustrates a front perspective view of the body 202; and FIG. 3B illustrates a rear perspective view of the body 202. In at least one implementation, the body 202 can include components for producing a stimulus which tests the health of a patient's tooth. For example, the body 202 can be configured to work with a tip which applies the stimulus to the patient's tooth. One of skill in the art will appreciate that a body can be used with different tips to produce different stimuli, as described below.

FIGS. 3A and 3B show that the body 202 can include a housing 302. In at least one implementation, the housing 302 is configured to surround the other elements of the body 202. For example, the housing 302 can ensure that electrical elements are properly insulated from one another and from outside electrical signals or from other debris such as dust. Additionally or alternatively, the housing 302 can serve to ensure that the other elements of the body 202 are oriented correctly relative to one another. One of skill in the art will appreciate that the housing 302 can cover all of the other components of the body 202 or only a portion thereof and that the housing 302 need not be exterior to the other components of the body 202.

In at least one implementation, the housing 302 can be made of any suitable material. For example, the housing 302 can be made of a metal, such as stainless steel or aluminum. Additionally or alternatively, the housing 302 can be made of plastic or other polymers. One of skill in the art will appreciate that the material can be selected for strength, water resistance, appearance or any other criteria.

FIGS. 3A and 3B also show that the body 202 can include an electronic display 304. In at least one implementation, the electronic display 304 can include an electronic device which conveys information to a user. For example, an electronic display 304 can include any display device for presentation of information for visual, tactile or auditive reception, acquired, stored, or transmitted in electronic form. In particular, an electronic display 304 is a device that receives an electronic signal as input and converts the electronic signal to a sensory signal that can be received by a user. For example, an electronic display 304 can include television sets, computer monitors, video display panels, projectors, liquid crystal displays (“LCD”s), light emitting diode (“LED”) displays or speakers. One of skill in the art will appreciate that the electronic display 304 can include any other device that converts an electronic signal into a sensory signal unless otherwise stated in the specification or the claims.

In at least one implementation, the electronic display 304 can produce multiple types of sensory signals. In particular, the electronic display 304 can include circuitry able to produce an image, which can be viewed by a viewer, and circuitry able to produce sound, which can he heard by the viewer. For example, the electronic display can include a visual display and a speaker. One of skill in the art will appreciate that the number of sensory signals produced by the electronic display 304 is not limiting unless otherwise stated in the specification or the claims.

For example, the electronic display 304 can include a screen. In at least one implementation, the screen serves as a surface for images to be shown on the electronic display 304. In particular, the electronic display 304 includes display circuitry which broadcasts an image, or series of images, that are shown on the screen. For example, the screen can be made of glass, plastic or other material that allows the display circuitry to broadcast the image on one side of the screen, while a user views the image from the other side of the screen. One of skill in the art will appreciate that the location of the display circuitry relative to the screen and to the user is not limiting unless otherwise stated in the specification or the claims.

Additionally or alternatively, the electronic display 304 can include one or more speakers. In at least one implementation, the speakers can include an electroacoustic transducer that converts an electrical signal into sound that can be perceived by a user. Specifically, the speaker can move in accordance with the variations of an electrical signal and causes sound waves to propagate through a medium. In particular, the speaker can be used to produce sound from a data signal sent to the electronic display 304. The speaker can be part of the electronic display 304 or can be an external device such as external speakers or headphones.

FIGS. 3A and 3B further show that the body 202 can include one or more user interfaces 306. In at least one implementation, the one or more user interfaces 306 can allow a user to input commands. For example, the one or more user interfaces 306 can include buttons, switches, touch screen inputs or any other input device. The user can select the appropriate user interface 306 to produce the desired stimulus. For example, there may be user interfaces 306 which produce heat, cold, electrical current, pressure or any other desired stimulus. Additionally or alternatively, the user interfaces 306 can allow the user to select from menu options or otherwise input the desired information. For example, the user interfaces 306 can allow the user to select a pre-programmed function which produces a stimulus for a specified amount of time or produces multiple stimuli in a pre-determined order.

FIGS. 3A and 3B additionally show that the body 202 can include a tip connection 308. In at least one implementation, the tip connection 308 can allow a tip to be connected to the body 202. The tip connection 308 can allow stimulus produced within the body 202 to be transmitted to a tip, which in turn transmits the stimulus to a patient's tooth. Additionally or alternatively, the tip connection 308 can allow the body 202 to transmit a command signal to the tip, instructing the tip to produce a stimulus.

FIGS. 3A and 3B also show that the body 202 can include a battery 310. In at least one implementation, the battery 310 can provide electrical or mechanical power to the other components. In particular, the battery 310 can include an energy storage device which is capable of powering the other components. For example, the battery 310 can include an electrochemical cell that converts chemical energy into electrical energy or a capacitor which stores electrical energy. Additionally or alternatively, the battery 310 can include a spring or other device capable of storing mechanical energy.

FIGS. 3A and 3B further show that the body 202 can include a power input 312. In at least one implementation, the power input 312 can be used to provide power to the battery 310. I.e., the power input 310 can allow the user to recharge the battery 310 or otherwise supply power to the body 202 and any components therein. For example, the power input 312 can include a wall plug or charging terminal which allows power to be received.

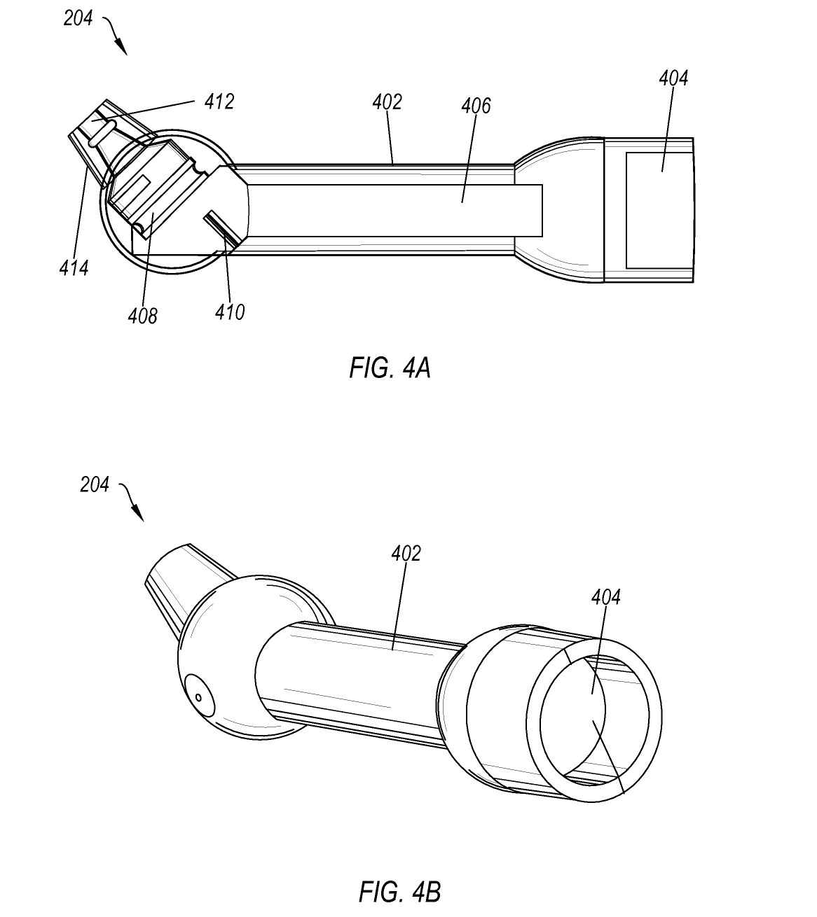

FIGS. 4A and 4B illustrate an example of a tip 204. FIG. 4A shows a side cut away view of the tip 204; and FIG. 4B shows a perspective view of the tip 204. In at least one implementation, the tip 204 can be attached to a body, such as the body 202 of FIGS. 3A and 3B, to apply a stimulus to the tooth of a patient. One of skill in the art will appreciate that a particular tip 204 can be configured to produce a particular stimulus. I.e., different tips 204 can produce different stimuli.

FIGS. 4A and 4B show that the tip 204 can include a housing 402. In at least one implementation, the housing 402 is configured to surround the other elements of the tip 204. For example, the housing 402 can ensure that electrical elements are properly insulated from one another and from outside electrical signals or from other debris such as dust. Additionally or alternatively, the housing 402 can serve to ensure that the other elements of the tip 204 are oriented correctly relative to one another. One of skill in the art will appreciate that the housing 402 can cover all of the other components of the tip 204 or only a portion thereof and that the housing 402 need not be exterior to the other components of the tip 204.

In at least one implementation, the housing 402 can be made of any suitable material. For example, the housing 402 can be made of a metal, such as stainless steel or aluminum. Additionally or alternatively, the housing 402 can be made of plastic or other polymers. One of skill in the art will appreciate that the material can be selected for strength, water resistance, appearance or any other criteria.

FIGS. 4A and 4B also show that the tip 402 can include a body connection 404. In at least one implementation, the body connection 404 can allow the tip 204 to be connected to a body, such as the body 202 of FIGS. 3A and 3B. In particular, the body connection 404 can allow the tip to receive stimuli and/or commands from the body to be applied to the tooth of a patient.

FIGS. 4A and 4B further show that the tip 402 can include a transfer apparatus 406. In at least one implementation, the transfer apparatus 406 can transfer a stimulus produced elsewhere to the tip, where it can be applied to a patient's tooth. Additionally or alternatively, the transfer apparatus 406 can transfer a signal to produce a stimulus to an appropriate device in the tip 402.

FIGS. 4A and 4B additionally show that the tip 402 can include a stimulus apparatus 408. In at least one implementation, the stimulus apparatus 408 can produce the desired stimulus. For example, the stimulus apparatus 408 can include a thermoelectric cooler. A thermoelectric cooler is a solid-state active heat pump which transfers heat from one side of the device to the other side against the temperature gradient (from cold to hot), with consumption of electrical energy. A thermoelectric cooler uses the Peltier effect to create a heat flux between the junction of two different types of materials. I.e., a thermoelectric cooler is a heat pump: when direct current runs through it, heat is moved from one side to the other. One of skill in the art will appreciate that the thermoelectric cooler can be used to produce both heat and cold to be applied to the patient's tooth. Additionally or alternatively, the stimulus apparatus 408 can include a resistor or other device for converting electrical current to heat.

Additionally or alternatively, the stimulus apparatus 408 can include an electrical stimulus. In at least one implementation, the electrical stimulus can include a device which is configured to apply an electric current to the patient's tooth. The electrical current can be limited to ensure that the application of current is not detrimental to the patient. For example, the stimulus apparatus 408 can include a current limiting circuit.

Additionally or alternatively, the stimulus apparatus 408 can include a motor or pneumatic device. In at least one implementation, the motor or pneumatic device can produce a movement or “tap” the patient's tooth. The tap can be configured to test the pressure sensitivity of the tooth. I.e., the tap can be a repeatable test which gives a benchmark when testing a patient's tooth for pressure sensitivity.

FIGS. 4A and 4B also show that the tip 204 can include a stimulus sensor 410. In at least one implementation, the stimulus sensor 410 can determine the amount of stimulus being applied to the patient's tooth. I.e., the stimulus sensor 410 can measure the temperature, pressure or electrical current being applied to the patient's tooth. Additionally or alternatively, the stimulus sensor 410 can measure the amount of stimulus being returned to the tip 204. I.e., the stimulus sensor 410 can measure the returning temperature, electric current or pressure, which can indicate the thermal conductivity, electrical conductivity and strength of the tooth, resulting in a measurement of tooth health.

FIGS. 4A and 4B further show that the tip 204 can include a stimulus conductor 412. In at least one implementation, the stimulus conductor 412 can transfer the stimulus to the patient's tooth. For example, the stimulus conductor 412 can include a thermally conductive rubber tip which transfers heat or cold to the patient's tooth. I.e., the stimulus conductor 412 can press against the patient's tooth, applying the stimulus to the external portion of the patient's tooth.

FIGS. 4A and 4B additionally show that the tip 204 can include a stimulus shell 414. In at least one implementation, the stimulus shell 414 can focus the stimulus on the patient's tooth. I.e., the shell 414 can be an insulator with regard to the stimulus. Therefore, the stimulus will propagate through the stimulus conductor 412 and be focused by the stimulus shell 414, allowing a high degree of control over the area in which the stimulus will be applied.

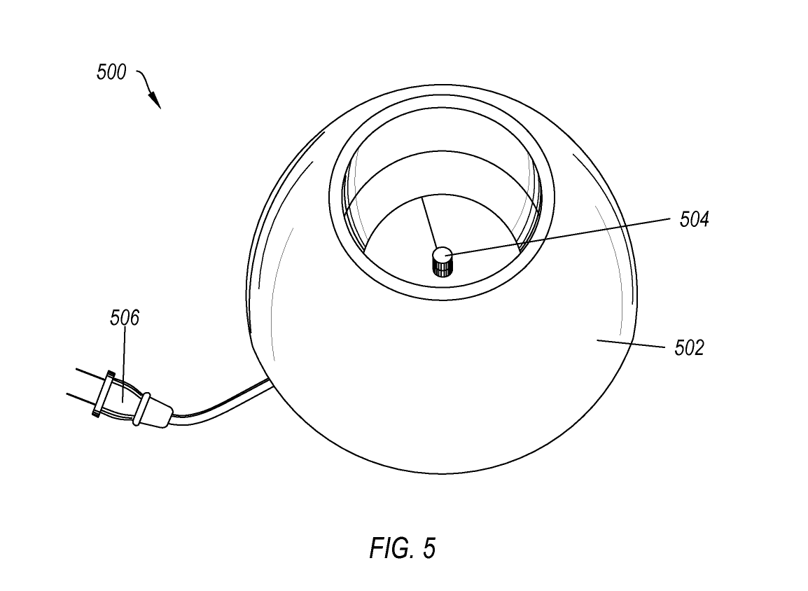

FIG. 5 illustrates a perspective view of a charger 500. In at least one implementation, the charger 500 can be used to charge a battery in a body, such as the body 202 of FIGS. 3A and 3B. In particular, the charger 500 can receive or store electrical power, or other power sources, and transform the power to a type that can be received by the body. For example, the charger 500 can transform the voltage or current from a wall outlet.

FIG. 5 shows that the charger 500 can include a base 502. In at least one implementation, the base 502 can support the body when in use. I.e., the base 502 can be configured to receive and support the body during charging. The base 502 can include weights or other stability increasing mechanisms. I.e., the base 502 can be balanced such that even when the body is in the charger 502, the body remains in the desired position.

FIG. 5 also shows that the charger 500 can include a power output 504. In at least one implementation, the power output 504 is configured to output power which will be delivered to the battery of the body. The power output 504 can be of a specific size and shape to ensure that only the desired body can be placed on the power output 504. I.e., the power output 504 can be configured to mate with only a desired body.

FIG. 5 further shows that the charger 500 can include a power input 506. In at least one implementation, the power input 506 can receive the desired power for the charger 500. For example, the power input 506 can include a wall plug, a pressurized fluid (such as air) or any other power source which can be used to produce the desired stimulus. The power input 506 can include a transformer or other device for altering the power before being output.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for testing the vitality of a tooth, the system comprising:
a stimulus output, wherein the stimulus output is configured to:
produce a stimulus; and
output the stimulus to a tooth of a patient; and
a controller, wherein the controller is configured to control the magnitude and duration of the stimulus produced by the stimulus output.

2. The system of claim 1 further comprising a stimulus feedback, wherein the stimulus feedback is configured to feedback regarding the stimulus applied to the tooth of the patient.

3. The system of claim 1, wherein the stimulus includes heat.

4. The system of claim 1, wherein the stimulus includes cold.

5. The system of claim 1, wherein the stimulus includes an electrical current.

6. The system of claim 1, wherein the stimulus includes pressure.

7. The system of claim 1, wherein the controller includes a safety system.

8. The system of claim 7, wherein the safety system is configured to disable the stimulus output if the stimulus surpasses a predetermined threshold.

9. A system for testing the vitality of a tooth, the system comprising:
a body, wherein the body includes:
a user interface, wherein the user interface allows a user to input one or more commands; and
a power source;
a stimulus apparatus, wherein the stimulus apparatus is configured to produce a stimulus; and
a tip, wherein the tip is configured to deliver the stimulus to the tooth of a patient.

10. The system of claim 9, wherein stimulus apparatus includes a thermoelectric cooler.

11. The system of claim 9, wherein stimulus apparatus includes an electrical stimulus.

12. The system of claim 9, wherein stimulus apparatus includes one of:
a motor; or
a pneumatic device.

13. The system of claim 9, wherein the tip includes:
a stimulus conductor, wherein the stimulus conductor is configured to transfer the stimulus to the tooth of the patient.

14. The system of claim 13, wherein the tip includes:
a stimulus shell, wherein the stimulus shell is configured to focus the stimulus within the stimulus conductor.

15. The system of claim 13, wherein the stimulus conductor includes a thermally conductive rubber tip.

16. A system for testing the vitality of a tooth, the system comprising:
a body, wherein the body includes:
a user interface, wherein the user interface allows a user to input one or more commands;
an electronic display, wherein the electronic display is configured to produce information to be received by a user;
a controller, wherein the controller is configured to control the production of a stimulus;
a tip connection;
a power source; and
a power input;
a stimulus apparatus, wherein the stimulus apparatus is configured to produce the stimulus; and
a tip, wherein the tip:
is configured to deliver the stimulus to the tooth of a patient; and includes:
a body connection, wherein the body connection is configured to mate with the tip connection of the body;
a transfer apparatus, wherein the transfer apparatus is configured to transmit signals from the body to the tip; and
a stimulus conductor, wherein the stimulus conductor is configured to transfer the stimulus to the tooth of the patient.

17. The system of claim 16 further comprising a charger.

18. The system of claim 16, wherein the controller includes one or more preprogrammed stimulus outputs.

19. The system of claim 18, wherein the preprogrammed stimulus output includes the duration of the stimulus.

20. The system of claim 18, wherein the preprogrammed stimulus output includes the magnitude of the stimulus.
